(19) United States
(12) Patent Application Publication
(10) Pub. No.: US 2015/0169508 A1
(43) Pub. Date: Jun. 18, 2015

(54) OBFUSCATING PAGE-DESCRIPTION LANGUAGE OUTPUT TO THWART CONVERSION TO AN EDITABLE FORMAT

(71) Applicant: Konica Minolta Laboratory U.S.A., Inc., San Mateo, CA (US)

(72) Inventor: Kurt N. Nordback, Portland, OR (US)

(73) Assignee: KONICA MINOLTA LABORATORY U.S.A., INC., San Mateo, CA (US)

(21) Appl. No.: 14/105,693

(22) Filed: Dec. 13, 2013

(51) Int. Cl. G06F 17/22; G06F 3/0484

(52) U.S. Cl. CPC G06F 17/2247; G06F 3/04842

(57) ABSTRACT

A method for managing an electronic document (ED), including: receiving a request to generate an obfuscated page-description language (PDL) file for the ED; identifying, within the ED, a first text flow comprising a plurality of characters; calculating a plurality of positions on a page for the plurality of characters; generating, in response to the request, a modified text flow by applying an obfuscation technique to the first text flow; and generating the obfuscated PDL file comprising the plurality of positions and the modified text flow.

### BACKGROUND

Electronic document (ED) description formats can generally be divided into two classes: markup-language (ML) formats and page-description language (PDL) formats. ML formats are intended for document creation and editing, and tend to describe a document's appearance and layout in higher-level terms. For instance, a ML might describe a paragraph of text by specifying margins, line pitch, font, font size, etc., and leave the details of determining the exact position of each character up to the software or device that is rendering the paragraph for display or printing. By contrast, PDL formats are not intended for editing. They are intended to facilitate faithful, efficient rendering of a document. In general, a PDL version of the paragraph would specify rather explicitly the positioning of each character in the text, but it would not specify higher-level data such as margins or line pitch since these are unnecessary if the only goal is accurate rendering.

Because PDL data has historically been considered not editable, users often convert a document from ML format to PDL format as a crude means of preventing modification. For instance, an author will commonly create and maintain a document in Open Office XML (OOXML) format, a type of ML format, for editability. However, the author will convert the file to portable document format (PDF), a type of PDL format, for distribution. The primary reason for this is portability of documents in PDF, but in some instances a secondary reason is that PDF format makes it more difficult for a recipient to modify the file for nefarious purposes, such as stealing the content or changing the file and passing it off as the work of the recipient.

Recently a wide variety of tools have emerged that allow back-conversion from PDL format (e.g., PDF) to ML format (e.g., OOXML). Because higher-level contextual information is lost in the conversion from ML format to PDL format, the conversion back from PDL format to ML format requires inferring or intuiting data, and therefore is generally faulty at best, and in many cases nearly useless. Nonetheless, in some instances it can allow creation of a facsimile of the original document that would be adequate to circumvent a distributor's goal of a non-modifiable format.

### SUMMARY

In general, in one aspect, the invention relates to a method for managing an electronic document (ED). The method comprises: receiving a request to generate an obfuscated page-description language (PDL) file for the ED; identifying, within the ED, a first text flow comprising a plurality of characters; calculating a plurality of positions on a page for the plurality of characters; generating, in response to the request, a modified text flow by applying an obfuscation technique to the first text flow; and generating the obfuscated PDL file comprising the plurality of positions and the modified text flow.

In general, in one aspect, the invention relates to a non-transitory computer readable medium (CRM) storing instructions for managing an electronic document (ED). The instructions comprising functionality for: displaying, to a user, a graphical user interface (GUI) comprising an option for generating an obfuscated page-description language (PDL) file for the ED; receiving a request to generate the obfuscated PDL file for the ED; identifying, within the ED, a first text flow comprising a plurality of characters; calculating a plurality of positions on a page for the plurality of characters; generating, in response to the request, a modified text flow by applying an obfuscation technique to the first text flow; and generating the obfuscated PDL file comprising the plurality of positions and the modified text flow.

In general, in one aspect, the invention relates to a system. The system comprises: a computer processor; a buffer configured to store an electronic document comprising a first text flow comprising a plurality of characters; a position engine executing on the computer processor and configured to calculate a plurality of positions of the plurality of characters on a page; an obfuscation engine executing on the computer processor and configured to generate a modified text flow by applying an obfuscation technique to the first text flow; and a page-description language (PDL) engine executing on the processor and configured to generate an obfuscated PDL file for the ED comprising the plurality of positions and the modified text flow.

Other aspects of the invention will be apparent from the following description and the appended claims.

### BRIEF DESCRIPTION OF DRAWINGS

FIG. 1 shows a system in accordance with one or more embodiments of the invention.

FIG. 2 shows a flowchart in accordance with one or more embodiments of the invention.

FIG. 3A and FIG. 3B show an example in accordance with one or more embodiments of the invention.

FIG. 4 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a system and method for managing an ED comprising one or more text flows. The ED may be in the Open Office XML (OOXML) format or any other ML format. In response to receiving a user request to generate an obfuscated PDL file for the ED, the positions (e.g., coordinates) of the text flows' characters are calculated. Then, one or more obfuscation techniques are applied to the PDL data (e.g., text flows, clipart, images, shapes, etc.) to generate modified PDL data. For example, obfuscation techniques are applied to text flows to generate modified text flows. The obfuscated PDL file includes the modified text flows and the calculated positions. The obfuscated PDL file may also include raster representations of any vector graphics in the ED. The obfuscated PDL file may be in PDF or any other PDL format. Like a standard PDL file, the obfuscated PDL file facilitates a faithful rendering of the ED. However, the obfuscated PDL file is more resilient than the standard PDL file against tools designed to convert a PDL file back to the original ML format (e.g., OOXML) or any other editable/modifiable format. In other words, the output of any such tool operating on the obfuscated PDL file will have little resemblance to the ED, reducing the utility of the output as a faithful and easily modifiable replica of the original.

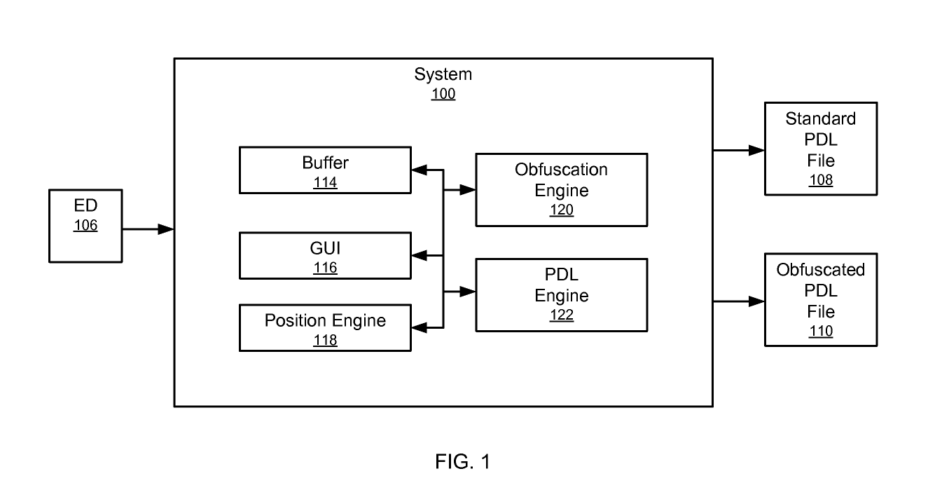

FIG. 1 shows a system (100) in accordance with one or more embodiments of the invention. As shown in FIG. 1, the system (100) has multiple components including a buffer (114), a graphical user interface (GUI) (116), a position engine (118), an obfuscation engine (120), and a PDL engine (122). Each of these components (114, 116, 118, 120, 122) may be located on the same hardware device (e.g., personal computer (PC), a desktop computer, a mainframe, a server, a telephone, a kiosk, a cable box, a personal digital assistant (PDA), an electronic reader, a smart phone, a tablet computer, etc.) or may be located on different hardware devices connected using a network having wired and/or wireless segments. In one or more embodiments of the invention, the system (100) inputs an ED (106) and outputs an obfuscated PDL file (110) for the ED (106). The system (100) may also output a standard PDL file (108) for the ED (106).

In one or more embodiments of the invention, the ED (106) includes one or more text flows. Each text flow may have any number of characters and thus any number of words. A text flow may correspond to a sentence, a paragraph, a text column, a footnote, a photo caption, an endnote, a section, a chapter, etc. There may be multiple text flows per page. A text flow may span multiple pages. The ED (106) may also include graphical features (e.g., photographs, vector graphics, clipart, shapes, etc.) to be displayed on or across one or more pages. Two or more of the graphical features may partially overlap. The ED (106) is represented/defined using a ML format (e.g., open document format (ODF), OOXML, etc.). Accordingly, the text flows, the graphical features, and the attributes of the text flows and graphical features, may be recorded/identified as attributes within the tags of the ML format. The text flows, the graphical features, and the attributes are needed to correctly render (e.g., display, print) the ED (106).

As discussed above, the ED (106) is editable/modifiable. Moreover, the ED (106) may be created and/or modified by a user application including, for example, a word-processing application, a spreadsheet application, a desktop publishing application, a graphics application, a photograph printing application, an Internet browser, a slide show generating application, a form generator, etc.

In one or more embodiments of the invention, the standard PDL file (108) is the ED (106) in a PDL format (e.g., PDF, XPS, etc.). The standard PDL file (108) facilitates faithful rendering of the ED (106). Accordingly, like the ED (106), the standard PDL file (108) includes the text flows and the graphical features. However, unlike the ED (106), the standard PDL file (108) includes explicit positions (e.g., x, y coordinates, offsets, etc.) for each character of each text flow and for each graphical feature. Moreover, unlike the ED (106), the standard PDL file (108) is not easily modifiable.

In one or more embodiments of the invention, the obfuscated PDL file (110) is the ED (106) in a PDL format (e.g., PDF, XPS, etc.). Like the standard PDL file (108), the obfuscated PDL file (110) facilitates faithful rendering of the ED (106) and includes explicit positions. In other words, essentially the same output would be generated by rendering (e.g., printing, displaying) either the standard PDL file (108) or the obfuscated PDL file (110). However, unlike the standard PDL file (108), the obfuscated PDL file includes modified versions of the one or more text flows or other data (discussed below). Moreover, unlike the standard PDL file (108), the obfuscated PDL file may include raster representations of any graphical feature (e.g., vector graphic, etc.) in the ED (106) (discussed below). Like the standard PDL file (108), the obfuscated PDL file (110) is also not easily modifiable.

Those skilled in the art, having the benefit of this detailed description, will appreciate that tools exist to convert a file in a PDL format to an ML format, and thus make the file editable. The obfuscated PDL file (110) is more resilient than the standard PDL file (108) against such tools because of at least the modified versions of the text flows and the raster representations of the graphical features. In other words, the output of any such tool operating on the obfuscated PDL file (110) will have little resemblance to the ED (106), making useful modification of the obfuscated PDL file difficult.

In one or more embodiments of the invention, the system (100) includes the GUI (116). The GUI (116) may be invoked from a user application (not shown) that is used to generate or modify the ED (106). Specifically, the GUI (116) may be invoked following a request to convert the ED (106) from an ML format to a PDL format. The GUI (116) may have any number of widgets (e.g., radio buttons, checkboxes, dropdown lists, buttons, etc.). By manipulating one or more widgets, the user may specify whether the standard PDL file (108) and/or the obfuscated PDL file (110) should be generated based on the ED (106).

In one or more embodiments of the invention, the system (100) includes the buffer (114). The buffer (114) may correspond to any type of memory or long-term storage (e.g., hard drive). The buffer (114) is configured to store the ED (106) following a request to generate the standard PDL file (108) and/or the obfuscated PDL file (110).

In one or more embodiments of the invention, the system (100) includes the position engine (118). The position engine (118) is configured to calculate positions for each character of each text flow in the ED (106). The position engine (118) is also configure to calculate positions for each graphical feature in the ED (106). In one or more embodiments, each position is specified as a coordinate pair (e.g., x-component, y-component) on a page. In one or more embodiments, each position is specified as an offset from a reference coordinate pair.

In one or more embodiments of the invention, the system (100) includes the obfuscation engine (120). The obfuscation engine (120) is configured to generate modified versions of the text flows by applying one or more obfuscation techniques to each text flow or other content. There are many possible obfuscation techniques that can be applied to a text flow or other content.

In one or more embodiments of the invention, one obfuscation technique includes scrambling the order of characters within a text flow to generate a modified text flow, so that the order of text in the PDL data differs from that in the ML data. For example, random characters within the text flow may swap locations. As another example, individual words within the text flow may be reversed. As yet another example, the entire order of the text flow may be reversed (i.e., the last character is now first and the first character is now last). In one or more embodiments of the invention, one obfuscation technique includes removing one or more characters from a text flow and adding them to a different text flow to generate a modified text flow.

Those skilled in the art, having the benefit of this detailed description, will appreciate that scrambling the order of characters in a text flow and/or removing characters from a text flow and adding them to a different text flow does not change the calculated positions of the characters. However, it does change the location of the characters in the PDL data (e.g., modified text flow). Specifically, it disassociates the order of the characters in the PDL data from the order of the characters as they appear on the screen or in a hardcopy. The purpose is to force a back-conversion tool (i.e., PDL to ML conversion tool) to interpret relationships among characters (such as their order in a flow of text, or the proper partitioning of characters in a document into a set of text flows) as much as possible solely from their geometry on the rendered page, rather than from the structure of the PDL data, the latter being generally much simpler from the standpoint of a computer program.

In one or more embodiments of the invention, one obfuscation technique includes partitioning a text flow into multiple PDL groups (e.g., PDF groups, XPS groups, etc.) to generate a modified text flow. For example, every second character of a text flow may be placed into a first PDL group, while the remaining characters of the text flow may be placed into a second PDL group. In other words, extraneous grouping of content is deliberately introduced in the PDL data, while hiding any grouping that may have existed in the original ML data. The intent is to deceive a back-conversion tool (i.e., PDL to ML conversion tool) that relies on such grouping structure in the PDL data to infer higher-level information (such as the proper partitioning of text content into text flows). This obfuscation technique may be used in combination with any other obfuscation technique(s).

In one or more embodiments of the invention, one obfuscation technique includes representing objects that are associated in the ML data using functionally equivalent but syntactically distinct constructs, in order to disguise their association. For example, assume there exists a text flow with characters that should all be colored black. A modified text flow may be created by setting the color space to RGB and the color to (0,0,0) for one subset of the characters, and setting the color space to Gray and the color to (0) for the remaining characters. This would not affect the rendered output (i.e., RGB (0,0,0) and Gray (0) are both black on the screen and in a hardcopy), but potentially could lead a simplistic back-conversion tool (i.e., PDL to ML conversion tool) to believe that the characters do not belong to the same text flow because of the different color spaces. The same technique could be applied to non-text data, such as path fills or path strokes.

In one or more embodiments of the invention, the obfuscation engine (120) is also configured to operate on graphical features in the ED (106). For example, the obfuscation engine (120) may generate a raster representation of a vector graphic in the ED. As another example, the obfuscation engine (120) may generate a single (i.e., composite) raster representation of multiple overlapping graphical features. Generally, it is more difficult for a PDL to ML conversion tool to analyze and extract high-lever information from a raster representation than a vector graphic.

In one or more embodiments of the invention, the obfuscation engine (120) is configured to intentionally use complex, PDL-specific constructs to represent data. For example, suppose the ED (106) includes a rectangle that is to be colored blue, and the PDL format to be created is PDF. The PDF representation could, instead of simply setting the color to blue, create a shading color space with a tensor patch gradient fill which, when evaluated, results in the constant color blue. Since tensor patch shading is not a feature of standard ML formats, and since determining that a tensor patch formula results in a solid color is somewhat difficult, it is highly likely the PDL to ML conversion tool would be unable to recreate the original, simple representation of the rectangle in the ML format.

Those skilled in the art, having the benefit of this detailed description, will appreciate that the obfuscation engine (120) is only used to generate the obfuscated PDL file (110), not the standard PDL file (108). Those skilled in the art, having the benefit of this detailed description, will also appreciate that it may take longer to generate the obfuscated PDL file (110) than the standard PDL file (108) because of the need to generate modified text flows, raster representations, etc. Similarly, it may take longer to render the obfuscated PDL file than the standard PDL file.

In one or more embodiments of the invention, the system (100) includes the PDL engine (122). The PDL engine (122) is configured to generate both the standard PDL file (108) and the obfuscated PDL file (110). Both the standard PDL file (108) and the obfuscated PDL file (110) include the positions calculated by the position engine (118). However, the obfuscated PDL file (110) includes the modified text flows, the raster representations, and any other creations of the obfuscation engine (120) (e.g., tensor patch gradient fill).

Although FIG. 1 shows a system (100) with a specific number and arrangement of components (114, 116, 118, 120, 122), those skilled in the art, having the benefit of this detailed description, will appreciate that other system configurations are also possible.

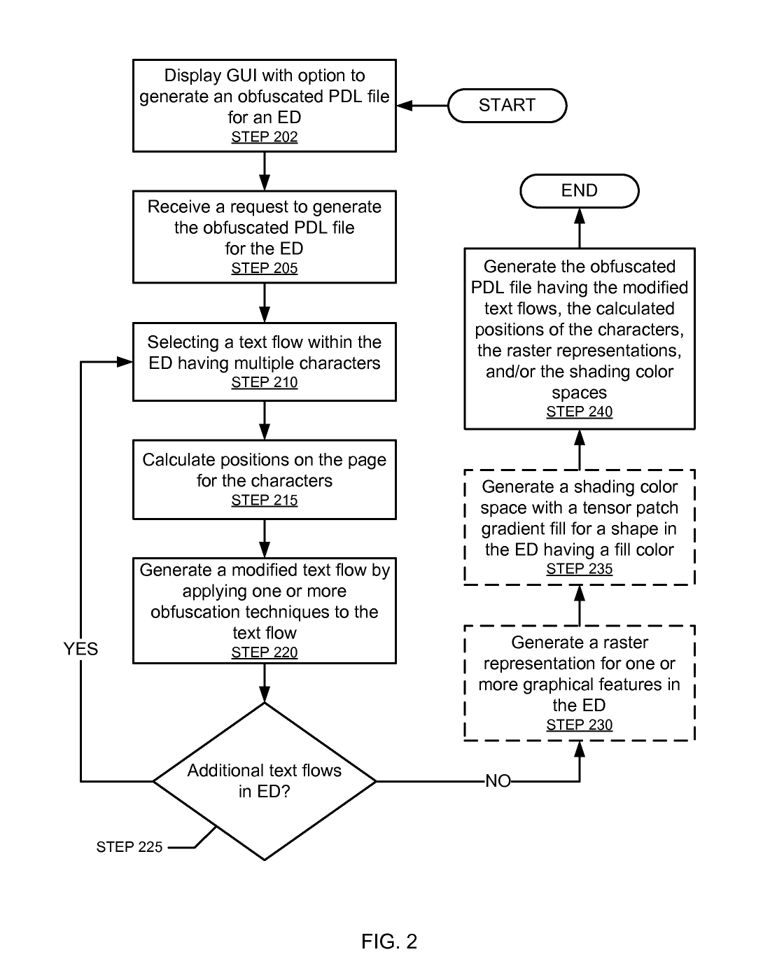

FIG. 2 shows a flowchart in accordance with one or more embodiments of the invention. The process shown in FIG. 2 may be executed, for example, by one or more components (e.g., position engine (118), obfuscation engine (120), PDL engine (122)) discussed above in reference to FIG. 1. In case the one more components are configured as software modules, the computer program codes are stored in the memory of the system (100), and the process is carried out by the processor reading out the program codes and executing the codes. One or more steps shown in FIG. 2 may be omitted, repeated, and/or performed in a different order among different embodiments of the invention. Accordingly, embodiments of the invention should not be considered limited to the specific number and arrangement of steps shown in FIG. 2.

Initially, a GUI with an option to generate an obfuscated PDL file is displayed (STEP 202). The GUI may be displayed in response to a user request to generate covert an ED in a ML format to a PFL format. The GUI may have multiple widgets including radio-buttons, checkboxes, drop-down boxes, buttons, etc. The user can manipulate one or more widgets to invoke options, including the option to generate the obfuscated PDL file instead of a standard PDL file.

In STEP 205, a request is received to generate the obfuscated PDL file. In other words, the user has specified that an obfuscated PDF file (and not the standard un-obfuscated file) is to be generated for the ED. The request may also specify the type of the PDL file (e.g., PDF, XPS, etc.).

In STEP 210, a text flow within the ED is selected. The text flows of the ED may be identified by parsing the ED (e.g., while the ED is stored in the buffer (114)). A text flow may be selected as it is encountered during the parsing. As discussed above, each text flow may have any number of characters and thus any number of words. A text flow may correspond to a sentence, a paragraph, a text column, a footnote, a photo caption, an endnote, a section, a chapter, etc. There may be multiple text flows per page. A text flow may span multiple pages.

In STEP 215, the position of each character in the text flow is calculated. The position may include a coordinate pair (e.g., x-component, y-component) for each character. Additionally or alternatively, the position may include an offset from a reference coordinate pair.

In STEP 220, a modified text flow is generated by applying one or more obfuscation techniques to the text flow. As discussed above, possible obfuscation techniques include scrambling the order of the characters in the text flow, removing characters from the text flow and adding the characters to another text flow, setting different color spaces for different characters in the same text flow, etc.

In STEP 225, it is determined whether additional text flows exist in the ED. When it is determined that additional text flows exist, the process returns to STEP 210. Otherwise, when it is determined that additional text flows do not exist, the process proceeds to STEP 230.

In STEP 230, raster representations of the graphical features (e.g., vector graphics) in the ED are generated. If two or more graphical features overlap, a single (i.e., composite) raster representation may be generated for the overlapping graphical features. STEP 230 may be omitted if no graphical features are present in the ED.

In STEP 235, a shading color space with a tensor patch gradient fill is created for any shape in the ED having a fill color. STEP 235 may be omitted if there are no shapes in the ED and/or if the type of PDL file being generated is not PDF. As discussed above, tensor patch gradient fill shading is a specialized feature of PDF and not a standard feature of ML formats. Moreover, it is highly unlikely any PDL to ML conversion tool would be able to evaluate the tensor patch gradient fill and determine it actually corresponds to a simple fill color.

In STEP 240, the obfuscated PDL file having the modified text flows, the calculated positions of the characters, the raster representations, and the shading color spaces is generated. The obfuscated PDF file may be distributed to any number of users. The obfuscated PDL file is more resilient than the standard PDL file against PDL to ML conversion tools because of at least the modified versions of the text flows and the raster representations of the graphical features. In other words, the output of any such tools operating on the obfuscated PDL file will have little resemblance to the ED, preventing the obfuscated PDL file from becoming modifiable.

Although in the exemplary embodiment mentioned above at least one obfuscation technique is applied to each text flow, in other embodiments of the invention, this technique might be applied to only some (i.e., not all) text flows or text flows that the user has selected in advanced. For instance, in STEP 202, a preview of the ED may be displayed on the GUI, and the user may select at least one text flow that he/she wants to obfuscate. In this case, the modified text flow is generated only for the selected text flow(s) in STEP 220.

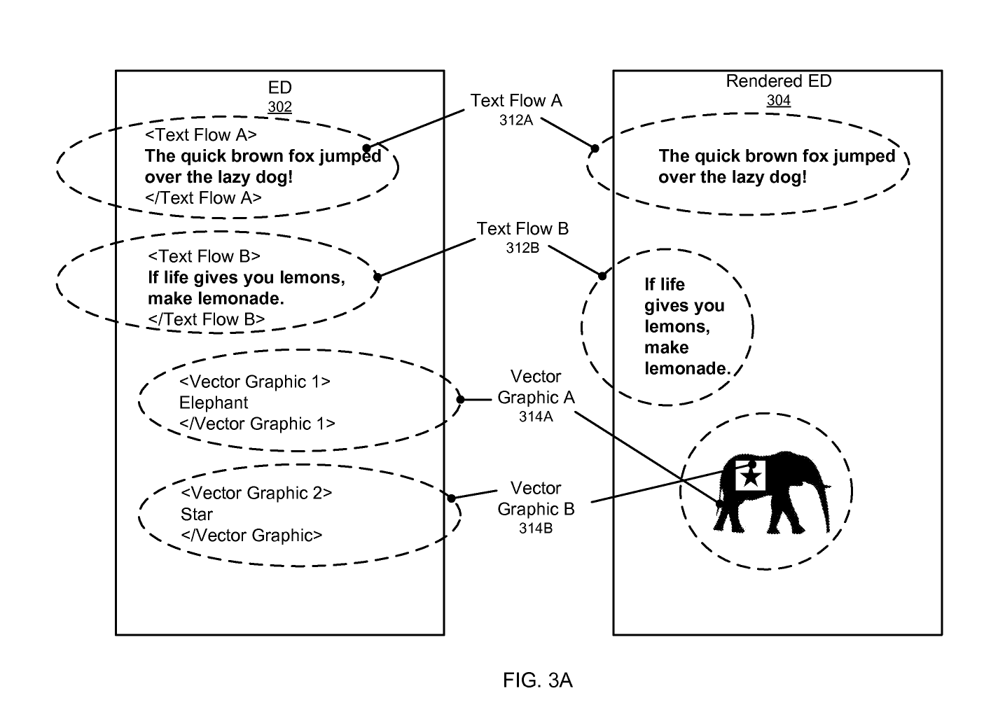

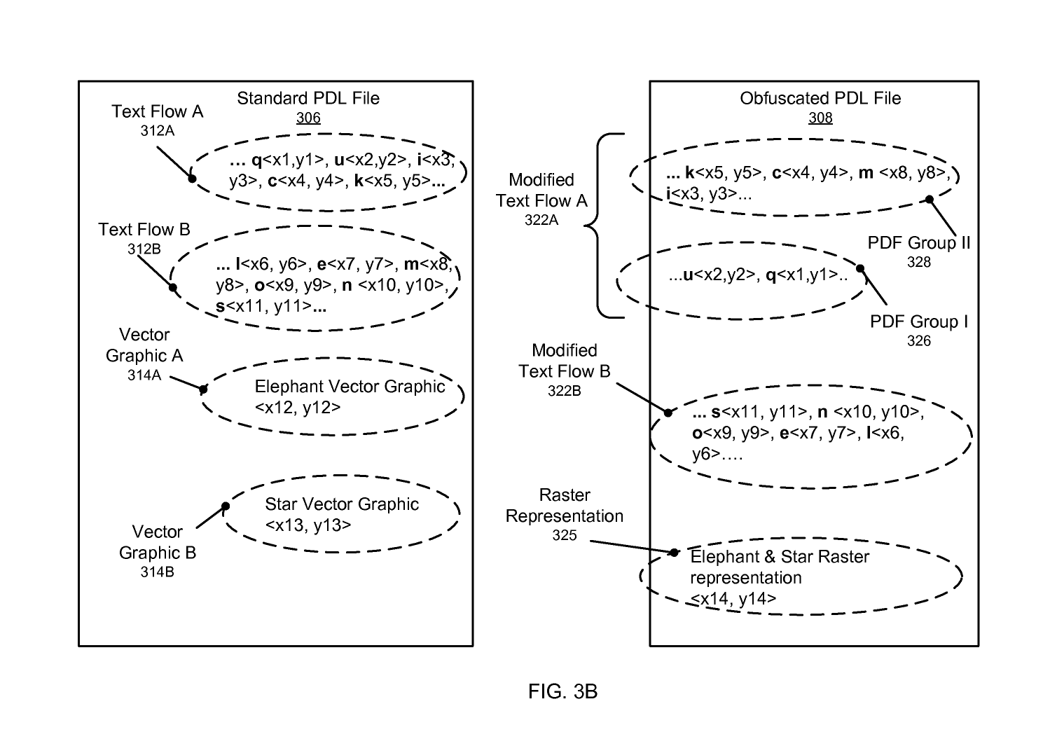

FIG. 3A and FIG. 3B show an example in accordance with one or more embodiments of the invention. In FIG. 3A, there exists an ED (302). The ED (302) may correspond to ED (106), discussed above in reference to FIG. 1. The ED (302) is in the OOXML format and thus is editable. The ED includes multiple text flows: Text Flow A (312A) and Text Flow B (312B). Each text flow (312A, 312B) has multiple words and thus multiple characters. The ED also includes two vector graphics: Vector Graphic A (314A) and Vector Graphic B (314B).

FIG. 3A also shows the rendered ED (304). In other words, the rendered ED (304) is the output when the ED (302) is displayed or printed. As shown in FIG. 3A, text flow A (312A) spans approximately the width of the page of the rendered ED (304), while text flow B (312B) is arranged in a column of the rendered ED (304). Moreover, the two vector graphic (314A, 314B) overlap in the rendered ED (304) (i.e., the star sits on top of the elephant).

FIG. 3B shows a standard PDL file (306) and an obfuscated PDL file (308). The standard PDL file (306) and the obfuscated PDL file (308) may correspond to the standard PDL file (108) and the obfuscated PDL file (110), discussed above in reference to FIG. 1. Both the PDL files (306, 308) may be in PDF. Moreover, both PDL files (306, 308) may facilitate faithful rendering of the ED (302). In other words, the output of rendering either the standard PDL file (306) or the obfuscated PDL file is essentially the same as the rendered ED (304).

As shown in FIG. 3B, the standard PDL file (306) includes text flow A (312A) and text flow B (312B). Only a portion of each text flow has been reproduced in FIG. 3B. Specifically, only the characters corresponding to “quick” in text flow A (312A) and the characters corresponding to “lemon” in text flow B (312B) are shown. More importantly, the standard PDL file (306) includes a position for each character. For example, the character “q” in text flow A (312A) has a position of <x1,y1>. As another example, the character “o” of “lemons” in text flow B (312B) has a position of <x9,y9>. Moreover, the standard PDL file (306) includes positions for both vector graphic A (314A) and vector graphic B (314B).

FIG. 3B also shows the obfuscated PDL file (308). Like the standard PFL file (306), the obfuscated PDL file (308) also has the position for each character. However, unlike the standard PFL file (306), the obfuscated PDL file (308) has modified text flows: Modified Text Flow A (322A) and Modified Text Flow B (322B). Only a portion of the modified text flows are shown. Modified text flow B (322B) is generated by applying an obfuscation technique to text flow B (312B) of the ED (302). Specifically, modified text flow B (322B) is generated by reversing each word in text flow B (312B) and removing the “m” in “lemons.” In other words, “lemons” becomes “snomel” following reversal, and then “snoel” following the removal of the “m.” Modified text flow A (322A) is generated by applying multiple obfuscation techniques to text flow A (312A) in the ED (302). Specifically, modified text flow A (322A) is generated by reversing all the words in text flow A (312A), inserting the “m” from text flow B (312B), and then partitioning the text flow into two PDF groups: PDF Group I (326) and PDF Group II (328). In other words, “quick” becomes “kciuq” following reversal, then “kcmiuq” following insertion of the “m,” and then “kcmi” and “uq” following the partitioning. The obfuscated PDL file (308) also includes a single composite raster representation (325) for vector graphic A (314A) and vector graphic B (314B), which overlap.

Those skilled in the art, having the benefit of this detailed description, will appreciate that the obfuscated PDL file (308) is more resilient than the standard PFL file (306) against a tool that converts PDL formats to ML formats. Specifically, the modified text flows (322A, 322B) make it extra difficult for such a tool to correctly assign characters to text flows and determine the order of characters in text flows. Moreover, the composite raster representation (325) makes it extra difficult, if not impossible, for such tools to extract the two separate vector images. In other words, the modified text flows (322A, 322B) and the composite raster representation (314) ensure the obfuscated PDL file (308) remains non-modifiable.

Embodiments of the invention may have one or more of the following advantages: the ability to prevent a PDL file from becoming easily modifiable; the ability to generate modified text flows; the ability to generate composite raster representations of overlapping vector graphics; the ability to generate PDL files that are resistant against PDL to ML conversion tools, etc.

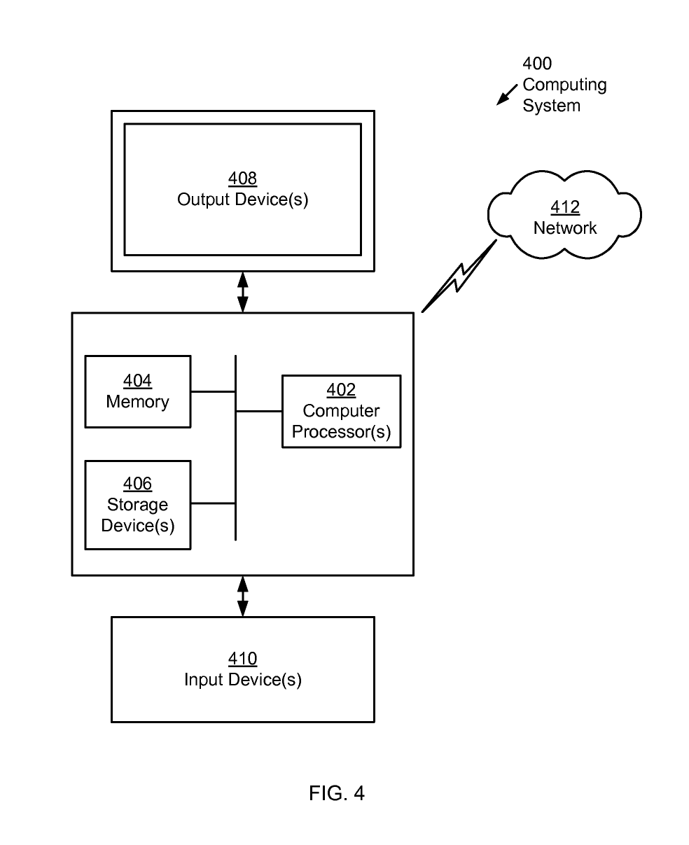

Embodiments of the invention may be implemented on virtually any type of computing system regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 4, the computing system (400) may include one or more computer processor(s) (402), associated memory (404) (e.g., random access memory (RAM), cache memory, flash memory, etc.), one or more storage device(s) (406) (e.g., a hard disk, an optical drive such as a compact disk (CD) drive or digital versatile disk (DVD) drive, a flash memory stick, etc.), and numerous other elements and functionalities. The computer processor(s) (402) may be an integrated circuit for processing instructions. For example, the computer processor(s) may be one or more cores, or micro-cores of a processor. The computing system (400) may also include one or more input device(s) (410), such as a touchscreen, keyboard, mouse, microphone, touchpad, electronic pen, or any other type of input device. Further, the computing system (400) may include one or more output device(s) (408), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (400) may be connected to a network (412) (e.g., a local area network (LAN), a wide area network (WAN) such as the Internet, mobile network, or any other type of network) via a network interface connection (not shown). The input and output device(s) may be locally or remotely (e.g., via the network (412)) connected to the computer processor(s) (402), memory (404), and storage device(s) (406). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (400) may be located at a remote location and connected to the other elements over a network (412). Further, embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for managing an electronic document (ED), comprising:
receiving a request to generate an obfuscated page-description language (PDL) file for the ED;
identifying, within the ED, a first text flow comprising a plurality of characters;
calculating a plurality of positions on a page for the plurality of characters;
generating, in response to the request, a modified text flow by applying an obfuscation technique to the first text flow; and
generating the obfuscated PDL file comprising the plurality of positions and the modified text flow.

2. The method of claim 1, further comprising:
displaying, to a user and prior to receiving the request, a graphical user interface (GUI) comprising an option for generating the obfuscated PDL file and an option for generating a standard PDL file for the ED,
wherein the request is generated in response to the user selecting the option for generating the obfuscated PDL file.

3. The method of claim 1, wherein the ED is an Open Office XML (OOXML) file, and wherein the PDL is portable document format (PDF).

4. The method of claim 1, wherein applying the obfuscation technique comprises:
changing an order of the plurality of characters.

5. The method of claim 4, wherein changing the order comprises reversing a plurality of words within the first text flow.

6. The method of claim 1, wherein applying the obfuscation technique comprises:
removing a character from a second text flow in the ED and inserting the character into the plurality of characters.

7. The method of claim 1, wherein applying the obfuscation technique comprises:
partitioning the plurality of characters into a plurality of PDL groups.

8. The method of claim 1, wherein applying the obfuscation technique comprises:
setting a first character of the plurality of characters to (0, 0, 0) in Red-Green-Blue (RGB) color space; and
setting a second character of the plurality of characters to (0) in Gray color space.

9. The method of claim 1, further comprising:
identifying, within the ED and in response to the request, a first vector graphic and a second vector graphic, wherein the first vector graphic and the second vector graphic partially overlap on the page; and
generating a raster representation of the first vector graphic partially overlapped with the second vector graphic,
wherein the obfuscated PDL file further comprises the raster representation.

10. The method of claim 1, further comprising:
identifying, within the ED and in response to the request, a shape and a fill color for the shape; and
generating a shading color space with a tensor patch gradient fill based on the fill color,
wherein the obfuscated PDL file comprises the tensor patch gradient fill.

11. A non-transitory computer readable medium (CRM) storing instructions for managing an electronic document (ED), the instructions comprising functionality for:
displaying, to a user, a graphical user interface (GUI) comprising an option for generating an obfuscated page-description language (PDL) file for the ED;
receiving a request to generate the obfuscated PDL file for the ED;
identifying, within the ED, a first text flow comprising a plurality of characters;
calculating a plurality of positions on a page for the plurality of characters;
generating, in response to the request, a modified text flow by applying an obfuscation technique to the first text flow; and
generating the obfuscated PDL file comprising the plurality of positions and the modified text flow.

12. The non-transitory CRM method of claim 11, wherein the instructions for applying the obfuscation technique comprise functionality for:
changing an order of the plurality of characters by reversing a plurality of words within the first text flow.

13. The non-transitory CRM of claim 11, wherein the instructions for applying the obfuscation technique comprise functionality for:
removing a character from a second text flow in the ED and inserting the character into the plurality of characters.

14. The non-transitory CRM of claim 11, wherein the instructions for applying the obfuscation technique comprise functionality for:
setting a first character of the plurality of characters to (0, 0, 0) in Red-Green-Blue (RGB) color space; and
setting a second character of the plurality of characters to (0) in Gray color space.

15. The non-transitory CRM of claim 11, wherein the instructions for applying the obfuscation technique further comprise functionality for:
partitioning the plurality of characters into a plurality of PDL groups.

16. A system, comprising:
a computer processor;
a buffer configured to store an electronic document comprising a first text flow comprising a plurality of characters;
a position engine executing on the computer processor and configured to calculate a plurality of positions of the plurality of characters on a page;
an obfuscation engine executing on the computer processor and configured to generate a modified text flow by applying an obfuscation technique to the first text flow; and
a page-description language (PDL) engine executing on the processor and configured to generate an obfuscated PDL file for the ED comprising the plurality of positions and the modified text flow.

17. The system of claim 16, wherein the ED is an Open Office XML (OOXML) file, and wherein the PDL is portable document format (PDF).

18. The system of claim 16, further comprising:
a graphical user interface (GUI) comprising an option for generating the obfuscated PDL and an option for generating a standard PDL file for the ED.

19. The system of claim 16, wherein applying the obfuscation technique comprises:
changing an order of the plurality of characters by reversing a plurality of words within the first text flow; and
removing a character from a second text flow in the ED and inserting the character into the plurality of characters.

20. The system of claim 16, wherein applying the obfuscation technique comprises:
partitioning the plurality of characters into a plurality of PDL groups;
setting a first PDL group of the plurality of PDL groups to (0, 0, 0) in Red-Green-Blue (RGB) color space; and
setting a second PDL group of the plurality of PDL groups to (0) in Gray color space.
